(19) United States
(12) Patent Application Publication
(10) Pub. No.: US 2017/0061642 A1
(43) Pub. Date: Mar. 2, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Kemiao WANG, Yokohama-shi (JP)

(73) Assignee: FUJI XEROX CO., LTD., Tokyo (JP)

(21) Appl. No.: 14/996,840

(22) Filed: Jan. 15, 2016

(30) Foreign Application Priority Data
Aug. 28, 2015 (JP) 2015-168967

(51) Int. Cl. G06T 7/20; G06F 17/24

(52) U.S. Cl. CPC G06T 7/2006; G06F 17/248

(57) ABSTRACT

An information processing apparatus includes a memory, a scene extracting unit, a determining unit, and a providing unit. The memory associatively stores, for each template, the template and a degree of first impression similarity indicating an impression of the template. The scene extracting unit extracts a scene from a moving image. The determining unit determines an impression of the extracted scene. The providing unit provides a harmonious combination of the scene and a template by using a degree of second impression similarity indicating the impression of the scene, and the degree of first impression similarity.

### CROSS-REFERENCE TO RELATED APPLICATIONS

This application is based on and claims priority under 35 USC 119 from Japanese Patent Application No. 2015-168967 filed Aug. 28, 2015.

### BACKGROUND

(i) Technical Field

The present invention relates to an information processing apparatus, an information processing method, and a non-transitory computer readable medium.

(ii) Related Art

There are cases in which an image is combined with a template representing an illustration or a landscape. For example, there is a case in which a captured image is combined with a template, and the result is printed. There are other cases in which a template such as an ad, direct mail (DM), a poster, a postcard, or a catalogue is prepared in advance, and an image is combined with that template.

By the way, when the user wants to generate a compilation by combining a moving image and a template, there has been no structure for generating a compilation that is harmonious as a whole, and it has been difficult to generate such a compilation. Even if character information extracted from the moving image is used, a compilation that is harmonious as a whole is not always generated.

### SUMMARY

According to an aspect of the invention, there is provided an information processing apparatus including a memory, a scene extracting unit, a determining unit, and a providing unit. The memory associatively stores, for each template, the template and a degree of first impression similarity indicating an impression of the template. The scene extracting unit extracts a scene from a moving image. The determining unit determines an impression of the extracted scene. The providing unit provides a harmonious combination of the scene and a template by using a degree of second impression similarity indicating the impression of the scene, and the degree of first impression similarity.

### BRIEF DESCRIPTION OF THE DRAWINGS

An exemplary embodiment of the present invention will be described in detail based on the following figures, wherein:

FIG. 1 is a block diagram illustrating a template management system according to an exemplary embodiment of the present invention;

FIG. 2 is a block diagram illustrating a template management apparatus according to the exemplary embodiment;

FIG. 3 is a block diagram illustrating a moving image analyzing unit;

FIG. 4 is a block diagram illustrating a moving image processing unit;

FIG. 5 is a block diagram illustrating a terminal apparatus;

FIG. 6 is a schematic diagram illustrating an exemplary template;

FIG. 7 is a diagram illustrating an exemplary taste map;

FIG. 8 is a diagram illustrating an exemplary taste map combined with a color palette;

FIG. 9 is a flowchart illustrating an exemplary process performed by the template management apparatus according to the exemplary embodiment;

FIG. 10 is a diagram illustrating an exemplary taste map;

FIG. 11 is a diagram illustrating an exemplary taste map;

FIG. 12 is a diagram illustrating an exemplary compilation; and

FIG. 13 is a diagram illustrating a template selecting screen.

### DETAILED DESCRIPTION

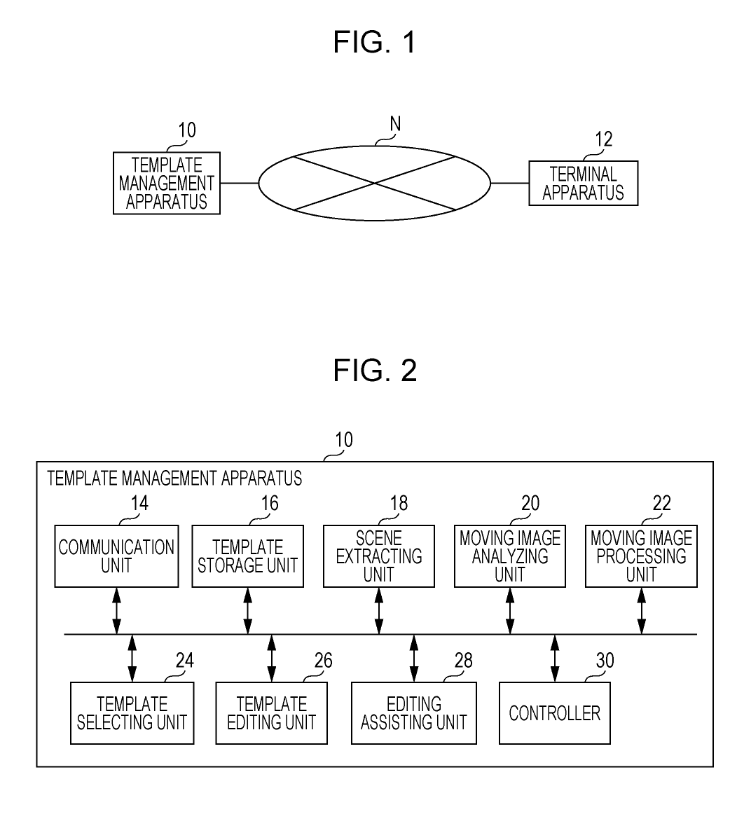

FIG. 1 illustrates an exemplary template management system serving as an information processing system according to an exemplary embodiment of the present invention. The template management system includes a template management apparatus 10 serving as an information processing apparatus, and a terminal apparatus 12. The template management apparatus 10 and the terminal apparatus 12 are connected to a communication path N such as a network. Although one terminal apparatus 12 is connected to the communication path N in the example illustrated in FIG. 1, multiple terminal apparatuses 12 may be connected to the communication path N.

The template management apparatus 10 has the function of managing a template for generating a compilation, and, in response to a request, providing the template. A compilation includes, for example, an ad, direct mail (DM), a poster, a postcard, a catalogue, other documents, and/or other images. A template is model data for generating that compilation. The template management apparatus 10 also has the function of transmitting/receiving data to/from another apparatus.

The terminal apparatus 12 is an apparatus such as a personal computer (PC), a tablet PC, a smart phone, or a mobile phone, and has the function of transmitting/receiving data to/from another apparatus. The terminal apparatus 12 is, for example, an apparatus used to generate a compilation using a template.

In the template management system according to the exemplary embodiment, at the time of editing a template, for example, data on the template is transmitted from the template management apparatus 10 to the terminal apparatus 12, and the template is displayed on the terminal apparatus 12. In response to an editing instruction given from the user using the terminal apparatus 12, the template is edited in accordance with the editing instruction using the template management apparatus 10 or the terminal apparatus 12.

Alternatively, the terminal apparatus 12 may be incorporated into the template management apparatus 10, and the terminal apparatus 12 and the template management apparatus 10 may be physically integrated as one apparatus.

Hereinafter, the configuration of the template management apparatus 10 will be described in detail. FIG. 2 illustrates the configuration of the template management apparatus 10.

A communication unit 14 is a communication interface, and has the function of transmitting data to another apparatus and receiving data from another apparatus via the communication path N. For example, the communication unit 14 transmits data on a template to the terminal apparatus 12, and receives moving image data transmitted from the terminal apparatus 12.

A template storage unit 16 is a storage device such as a hard disk, and stores data on a template. For example, multiple types of templates with different designs are generated in advance, and data on these templates is stored in advance in the template storage unit 16. For data on each template, template identification information for identifying that template (such as a template ID or a template name), template taste information, a template sensibility keyword, and sample information are associated in advance.

A template includes, for example, a background area, an image display area where an image is displayed, and a character string display area where a character string is displayed. An image or a figure, for example, is displayed in the background area and the image display area. The template includes, as the character string display area, for example, a title display area where a character string regarding a title is entered, a caption display area where a character string regarding a caption (description or the like) is entered, and a details display area where a character string regarding a detailed description is entered.

Template taste information is information indicating the taste (impression) of a template. The taste is, for example, determined in advance on the basis of a taste model that classifies an impression that a person has towards a target. In the taste model, impressions are classified into multiple types in accordance with the hue or tone of a target. The taste of a template is determined in accordance with the hue or tone of the template. For example, a dominant hue or tone of a template is determined, and the taste of the template is determined in accordance with the dominant hue or tone. For example, a taste map indicating a distribution of tastes is generated in advance, and template taste information is a taste value indicating a pair of coordinates on the taste map. The taste of a template may be determined in accordance with, for example, the layout of a later-described sample image or sample character string, the font size or type of the sample character string, or the size of the sample image. Note that the taste of a template corresponds to an example of a degree of first impression similarity.

A template sensibility keyword is a character string that indicates the taste of a template. A template sensibility keyword is, for example, a character string that indicates a taste corresponding to the above-mentioned taste value.

Sample information is, for example, character string data (sample character string) or image data (sample image) generated in advance as a sample. Both the sample character string and the sample image may be used as a sample, or only one of the sample character string and the sample image may be used as a sample. For sample information, sample identification information for identifying that sample (such as a sample ID or a sample name), sample taste information, a sample sensibility keyword, and information indicating the size of the sample on a template are associated in advance. In a template, for example, a sample character string may be entered in advance in the character string display area, or a sample image may be entered in advance in the image display area or the background area. Sample information is information whose editing by the user is permitted, and, when sample information is edited, a compilation that is based on a template is generated. A template may further include an area whose editing by the user is prohibited.

Sample taste information is information indicating the taste of a sample. The taste of a sample image is determined in accordance with, for example, a hue or a tone. The taste of a sample character string is determined in accordance with, for example, the size or type of a font. A sample sensibility keyword is a character string that indicates the taste of a sample. A sample sensibility keyword is, for example, a character string that indicates a taste corresponding to a taste value, like a template sensibility keyword.

A scene extracting unit 18 has the function of extracting data on an independent scene from moving image data. The scene extracting unit 18 extracts scene data by, for example, applying the related art of shot boundary detection to moving image data. In general, the basic structural unit of moving image data is a shot (scene), and a joint between two shots (scenes) is called a shot boundary. By detecting shot boundaries, individual scenes (shots) are extracted. As shot boundary detection, for example, cut boundary detection or gradual boundary detection is used. A cut boundary is a boundary between scenes (shots) switched every frame. By applying cut boundary detection, cut boundaries are detected, and accordingly individual scenes (shots) are extracted. A gradual boundary is a boundary between scenes (shots) switched every multiple frames. Gradual boundaries include a fade boundary where brightness gradually changes, and a wipe boundary where a frame changes to another while gradually replacing with another. By applying gradual boundary detection, fade boundaries or wipe boundaries are detected, and accordingly individual scenes (shots) are extracted.

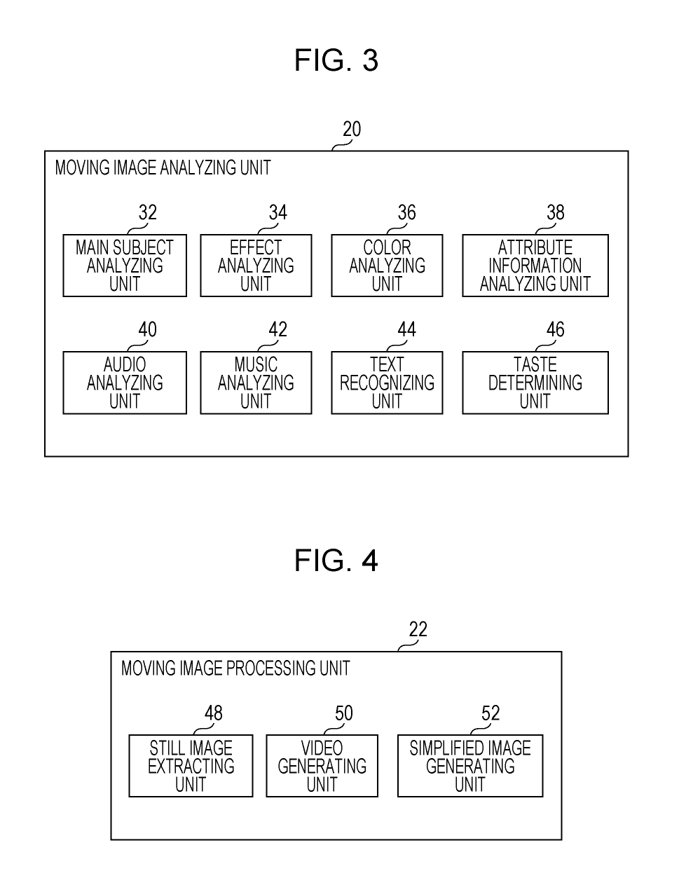

A moving image analyzing unit 20 has the function of determining the taste (impression) of a scene on the basis of at least one of the hue or tone of the scene, the type of visual effects in the scene, audio data that accompanies the scene, and music data that accompanies the scene, and generating scene taste information indicating that taste. The moving image analyzing unit 20 may also generate a scene sensibility keyword. A scene sensibility keyword is a character string that indicates the taste of a scene, and, for example, is a character string that indicates a taste corresponding to a taste value. The moving image analyzing unit 20 may determine a taste for each scene, or may determine the taste of a scene selected by the user. The taste of a scene corresponds to an example of a degree of second impression similarity. The moving image analyzing unit 20 will be described in detail with reference to FIG. 3.

A moving image processing unit 22 has the function of extracting still image data from data on a scene, the function of generating video data, and so forth. The moving image processing unit 22 may apply a process to each scene, or may apply a process to a scene selected by the user. The moving image processing unit 22 will be described in detail with reference to FIG. 4.

A template selecting unit 24 has the function of selecting a template that is in harmony with a scene, from a template collection stored in the template storage unit 16, by using template taste information and scene taste information. The template selecting unit 24 may select a template that is in harmony with each scene, may select a template that is in harmony with a scene selected by the user, or may select a template that is in harmony with multiple scenes.

The template selecting unit 24 may select, for example, a template that has the same taste as the taste of a scene. In another example, the template selecting unit 24 may select a template associated with the same template sensibility keyword as the scene sensibility keyword. In the case where multiple scene sensibility keywords are generated, the template selecting unit 24 selects a template corresponding to each of the scene sensibility keywords. In doing so, multiple templates are selected.

In yet another example, the template selecting unit 24 may select a template that has a taste included in a harmonious range of the taste of a scene. The harmonious range is a range defined, for example, with reference to a position corresponding to the taste of a scene on a taste map. The harmonious range is, for example, a preset range. The harmonious range may be changed by the user or the administrator, for example. The template selecting unit 24 may select, for example, a template in which, on the taste map, the difference between a position corresponding to the taste of a scene and a position corresponding to the taste of the template is less than or equal to a threshold. The threshold is, for example, a preset range. The threshold may be changed by the user or the administrator, for example. Alternatively, the template selecting unit 24 may select a template associated with a template sensibility keyword included in the harmonious range of the scene sensibility keyword. The template selecting unit 24 may select, for example, a template in which, on the taste map, the difference between a position corresponding to the scene sensibility keyword and a position corresponding to the template sensibility keyword is less than or equal to a threshold.

A template editing unit 26 has the function of editing a template. At the time of editing a template, the user uses the terminal apparatus 12 to edit the details of the image display area or the character string display area. Note that editing includes changes, addition, and deletion of information. In the character string display area, for example, a character string is entered or changed, a font is set, the size of characters is set, the color of characters is set, or the arrangement position of characters is changed. In the image display area, for example, an image is added or changed, an image size is changed, or the arrangement position of an image is changed. In addition, the position or size of the image display area or the character string display area may be changed. With such an editing operation, a compilation that is based on a template is generated.

In addition, the template editing unit 26 has the function of combining a still image or a video image extracted from a scene with a template.

An editing assisting unit 28 has the function of assisting the user in editing a template. The editing assisting unit 28 has the function of proposing the color of characters or the background included in a template such that the color fits the taste of a scene, the function of proposing the arrangement position of an object included in a template, the function of trimming an image combined with a template, the function of entering a character string in a template, and so forth.

A controller 30 has the function of controlling the operation of each unit of the template management apparatus 10. The controller 30 has, for example, the function of adding, deleting, and displaying a template. The controller 30 stores data on a newly registered template, for example, in the template storage unit 16. The controller 30 also has the function of displaying a template on the terminal apparatus 12. The controller 30 has the function of displaying, on the terminal apparatus 12, a template selected by the template selecting unit 24, the thumbnail image (size-reduced image) of a template, or a template designated by the user.

Hereinafter, the moving image analyzing unit 20 will be described in detail with reference to FIG. 3. FIG. 3 illustrates the configuration of the moving image analyzing unit 20.

The moving image analyzing unit 20 includes, for example, a main subject analyzing unit 32, an effect analyzing unit 34, a color analyzing unit 36, an attribute information analyzing unit 38, an audio analyzing unit 40, a music analyzing unit 42, a text recognizing unit 44, and a taste determining unit 46.

The main subject analyzing unit 32 has the function of identifying the type of a main subject represented in a scene. For example, the main subject analyzing unit 32 calculates an area occupied by each subject in a scene by analyzing each frame (each still image) included in the scene, identifies a subject who occupies the largest area as a main subject, and identifies the type of the main subject. In another example, the main subject analyzing unit 32 may calculate an appearance time in which each subject appears in the scene, and identify a subject who has the longest appearance time as a main subject. In yet another example, the main subject analyzing unit 32 may calculate each subject's occupied area and appearance time, calculate an evaluation value from the occupied area and the appearance time (such as the product of the occupied area and the appearance time), and identify a subject with the maximum evaluation value as a main subject. Possible types of the main subject include, for example, a person, a still life, an animal, and a landscape. For example, the main subject analyzing unit 32 extracts feature information indicating a feature of the main subject from the scene, and identifies a type with the same or similar feature as the type of the main subject. The main subject analyzing unit 32 may identify the type of the main subject in each scene, or may identify the type of the main subject represented in a scene selected by the user.

The effect analyzing unit 34 has the function of identifying the type of visual effects used in switching between scenes included in moving image data by analyzing each scene. Visual effects include, for example, a fade effect where brightness gradually changes, and a wipe effect where a frame changes to another while gradually replacing with another.

The color analyzing unit 36 has the function of obtaining a dominant hue or tone in a scene. The color analyzing unit 36 may determine the hue or tone of each scene, or may determine the hue or tone of a scene selected by the user.

The attribute information analyzing unit 38 has the function of analyzing moving image attribute information that accompanies moving image data. Moving image attribute information includes, for example, information indicating the date and time at which the moving image has been captured, information indicating the place where the image has been captured, information indicating the season when the moving image has been captured, information indicating the weather when the moving image has been captured, information indicating image capturing conditions (such as a condition regarding lenses), information indicating the format of the moving image, and information indicating the distance to a subject. For example, the place where the moving image has been captured is identified using the Global Positioning System (GPS) function. In addition, the weather is estimated from the time and date and the place where the moving image has been captured.

The audio analyzing unit 40 has the function of extracting a person's audio data that accompanies scene data, analyzing the audio data, and identifying the speaking speed, emotion, sex, and age of the person. The audio analyzing unit 40 may determine audio of each scene, or may determine audio included in a scene selected by the user.

The music analyzing unit 42 has the function of extracting music data that accompanies scene data, analyzing the music data, and identifying the type of music, the type of rhythm, and the type of principal instrument(s). The music analyzing unit 42 may determine music in each scene, or may determine music included in a scene selected by the user.

The text recognizing unit 44 has the function of applying audio recognition processing to audio data that accompanies a scene, and accordingly generating text data (character information) from the audio data.

The taste determining unit 46 has the function of determining the taste of a scene, on the basis of the above-mentioned analysis result. For example, the taste determining unit 46 has the function of determining the taste (impression) of a scene on the basis of at least one of the hue or tone of the scene, the type of visual effects in the scene, audio data that accompanies the scene, and music data that accompanies the scene, and generating scene taste information indicating that taste. The taste determining unit 46 may also generate a scene sensibility keyword. Scene taste information is, for example, a taste value indicating a pair of coordinates on a taste map.

For example, the template storage unit 16 stores taste information for colors. In taste information for colors, taste identification information for identifying a taste (such as a taste ID or a taste name), information indicating a hue or a tone corresponding to the taste (such as a color palette), and a sensibility keyword indicating the taste are associated. By referring to the taste information for colors, the taste determining unit 46 identifies a taste corresponding to the hue or tone of a scene.

In addition, the template storage unit 16 may store taste information for visual effects. In taste information for visual effects, taste identification information, information indicating the type of visual effects corresponding to that taste, and a sensibility keyword are associated. By referring to the taste information for visual effects, the taste determining unit 46 identifies a taste corresponding to the type of visual effects in a scene.

In addition, the template storage unit 16 may store taste information for audio. In taste information for audio, taste identification information, audio information corresponding to that taste (such as information indicating the speaking speed, information indicating the emotion of the person, information indicating the sex of the person, or information indicating the age of the person), and a sensibility keyword are associated. By referring to the taste information for audio, the taste determining unit 46 identifies a taste corresponding to the analysis result of audio recorded in a scene. Specifically, a taste corresponding to the speaking speed, emotion, sex, or age of the person is identified.

In addition, the template storage unit 16 may store taste information for music. In taste information for music, taste identification information, music information corresponding to that taste (such as information indicating the type of music, information indicating the type of rhythm, or information indicating the type of principal instrument(s)), and a sensibility keyword are associated. By referring to the taste information for music, the taste determining unit 46 identifies a taste corresponding to the analysis result of music recorded in a scene. Specifically, a taste corresponding to the type of music, the type of rhythm, or the type of principal instrument(s) is identified.

The taste determining unit 46 determines the taste of a scene by using at least one taste among a taste identified from a hue or tone (first taste), a taste identified from visual effects (second taste), a taste identified from audio (third taste), and a taste identified from music (fourth taste). The taste determining unit 46 may alternatively select multiple tastes from the first, second, third, and fourth tastes, and may regard the average of the multiple tastes as the taste of a scene. The taste determining unit 46 may calculate, for example, on a taste map, the average, median, or centroid of taste values of multiple tastes, and determine a taste corresponding to the average, median, or centroid as the taste of a scene.

Hereinafter, the moving image processing unit 22 will be described in detail with reference to FIG. 4. FIG. 4 illustrates the configuration of the moving image processing unit 22.

The moving image processing unit 22 includes, for example, a still image extracting unit 48, a video generating unit 50, and a simplified image generating unit 52.

The still image extracting unit 48 has the function of extracting, from data on a scene, data on a still image where a main subject is represented. For example, the still image extracting unit 48 calculates an area occupied by a main subject in each frame (each still image) included in a scene by analyzing the frame, and preferentially extracts a frame (still image) where that occupied area is relatively large. The still image extracting unit 48 extracts, for example, a frame (still image) in which the occupied area is the largest as a still image in which a main subject is represented. The still image extracting unit 48 may extract a preset number of frames (still images), starting from a frame (still image) in which the occupied area is the largest. The number of frames to be extracted may be changed by the user or the administrator, for example. The still image extracting unit 48 may extract still image data from each scene, or may extract still image data from a scene selected by the user. The extracted still image(s) is/are displayed on, for example, the terminal apparatus 12.

The video generating unit 50 has the function of generating video data from data on a scene. The video generating unit 50 may generate video data from each scene, or may generate video data from a scene selected by the user.

The simplified image generating unit 52 has the function of generating simplified video data with a reduced data amount from video data generated by the video generating unit 50. Animation in the Gif format, for example, is generated as simplified video data.

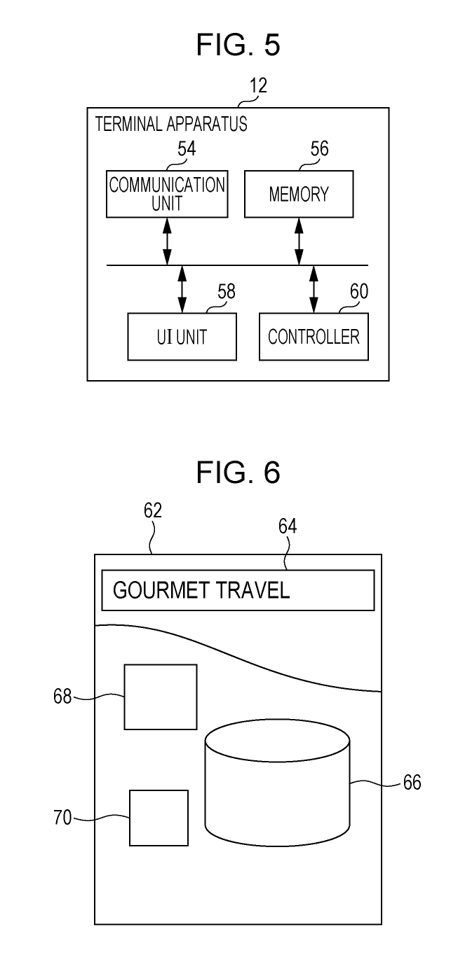

Hereinafter, the terminal apparatus 12 will be described in detail. FIG. 5 illustrates the configuration of the terminal apparatus 12.

A communication unit 54 is a communication interface, and has the function of transmitting data to another apparatus and receiving data from another apparatus via the communication path N. For example, the communication unit 54 receives data on a template transmitted from the template management apparatus 10, and transmits moving image data to the template management apparatus 10. A memory 56 is a storage device such as a hard disk, and stores programs and data. A UI unit 58 is a user interface, and includes a display and an operation unit. The display is a display device such as a liquid crystal display, and the operation unit is an input device such as a keyboard, a mouse, and/or a touchscreen. A controller 60 has the function of controlling the operation of each unit of the terminal apparatus 12.

Hereinafter, a template will be described in detail with reference to FIG. 6. FIG. 6 illustrates an example of a template. A template 62 includes, for example, a character string display area, a background area, and image display areas. A sample character string 64 is entered in advance in the character string display area; a sample image 66 is entered in advance in the background area; and sample images 68 and 70 are entered in advance in the image display areas. Since an image is entered in the background area, the background area also corresponds to an image display area. Therefore, the template 62 includes three image display areas including the background area. At the time of editing a template, for example, a list of templates registered in the template management apparatus 10 is displayed on the UI unit 58 of the terminal apparatus 12. When the user selects the template 62 from the list, the template 62 is displayed on the UI unit 58 of the terminal apparatus 12. On the terminal apparatus 12, the user enters a character string in a character string display area, or enters an image in an image display area. Alternatively, the user edits a sample character string, or changes a sample image to another image.

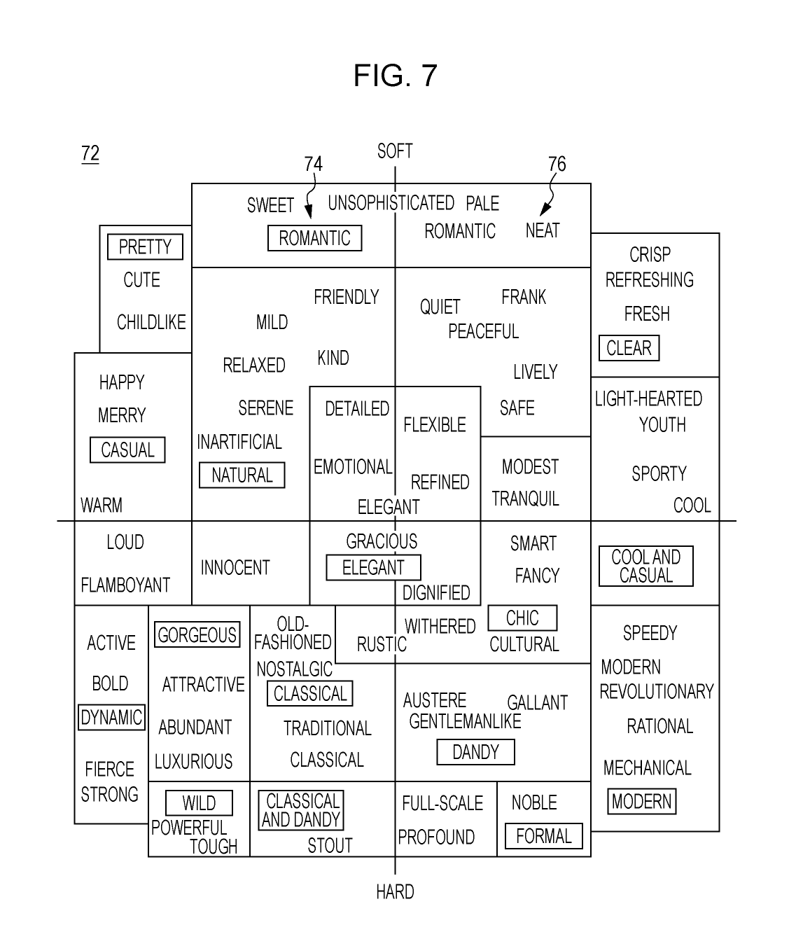

Hereinafter, a taste map will be described in detail with reference to FIG. 7. FIG. 7 illustrates an example of the taste map. A taste map is generated in advance, and data thereof is stored in, for example, the template storage unit 16. A taste map 72 is, for example, a two-dimensional map defined by two axes. A taste name serving as taste identification information and a sensibility keyword are associated in advance with each pair of coordinates on the taste map 72. In other words, each pair of coordinates on the taste map 72 corresponds to a taste value indicating a corresponding one of tastes. By specifying a pair of coordinates on the taste map 72, a taste and a sensibility keyword corresponding to that pair of coordinates are identified. On the taste map 72, the horizontal axis is an index axis defining “warm” and “cool”, which are taste indices, and the vertical axis is an index axis defining “hard” and “soft”, which are taste indices. For example, the taste becomes “cooler” as the area moves to the right. In other words, a taste that is “cooler” is associated with an area nearer the right end. In contrast, the taste becomes “warmer” as the area moves to the left. In other words, a taste that is “warmer” is associated with an area nearer the left end. In addition, the taste becomes “softer” as the area moves up. In other words, a taste that is “softer” is associated with an area nearer the top. In contrast, the taste becomes “harder” as the area moves down. In other words, a taste that is “harder” is associated with an area nearer the bottom.

In the example illustrated in FIG. 7, the taste map 72 is divided into multiple areas, and taste identification information (such as the taste “romantic” indicated by reference numeral 74) is associated with each area. In addition, a sensibility keyword (such as the sensibility keyword “neat” indicated by reference numeral 76) is associated with each pair of coordinates. Note that a taste map may be a map with three or more dimensions, or may be a one-dimensional map.

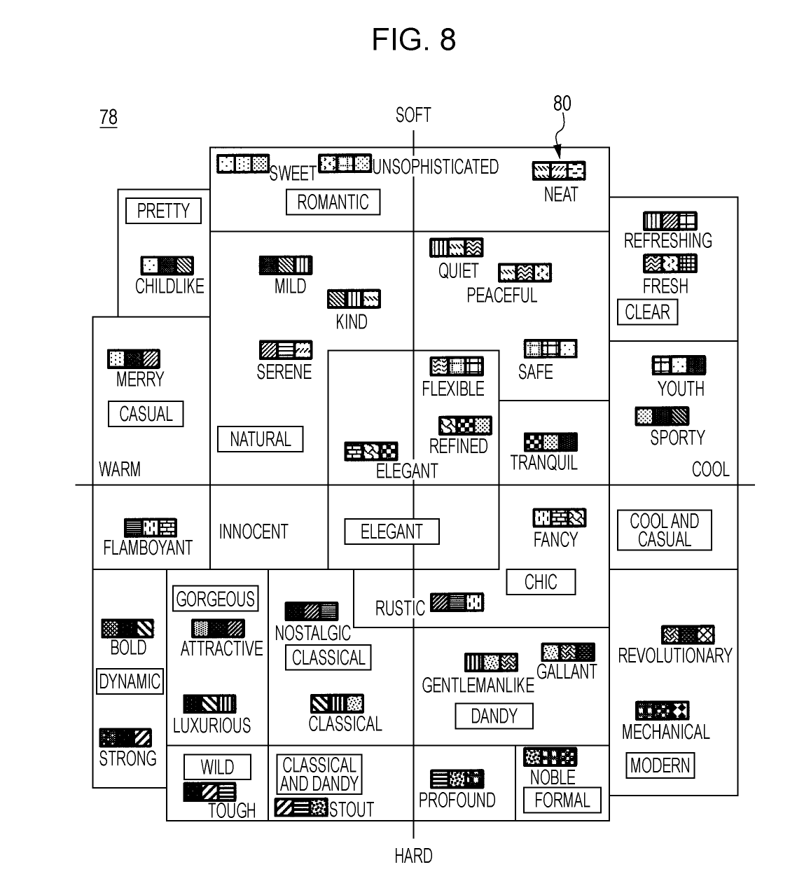

FIG. 8 illustrates an example of a taste map for colors. Taste identification information and a sensibility keyword are associated with each pair of coordinates on a taste map 78 for colors, and additionally a color palette (such as a color palette indicated by reference numeral 80) is associated with each pair of coordinates. A color palette is information indicating the hue or tone of a taste corresponding to the position of that color palette. For example, by using the color palette, the taste of a scene or the taste of a template is determined. The taste map 78 is generated in advance, and data thereof is stored in, for example, the template storage unit 16.

The color analyzing unit 36 analyzes, for example, the hue and tone of all pixels of multiple frames (multiple still images) included in a scene, and, for each combination of the hue and the tone, counts the number of pixels belonging to that combination. The color analyzing unit 36 determines a combination of the hue and the tone with the greatest number of pixels as a combination of the hue and the tone of that scene. By referring to the taste map 78, the taste determining unit 46 determines a taste corresponding to a combination of the hue and the tone with the greatest number of pixels as the taste of that scene. A sensibility keyword corresponding to that taste corresponds to a scene sensibility keyword of that scene. In another example, the taste determining unit 46 may generate, for each combination of the hue and the tone, a circle with a diameter in accordance with the number of pixels on the taste map 78, and may determine a taste corresponding to the centroid of multiple circles as the taste of that scene. In yet another example, a taste may be determined using L*, a*, and b* defined on the coordinates in the Lab color space. The taste of a sample image is determined in advance by the same or similar method. In addition, the taste of a template may be determined in advance by the same or similar method, or may be determined in advance in accordance with the layout or font size of a sample character string, a font type, or the size of a sample image.

As taste maps other than the taste map for colors, for example, a taste map for visual effects, a taste map for audio, and a taste map for music are generated in advance, and data thereof are stored in, for example, the template storage unit 16.

Taste identification information and a sensibility keyword are associated with each pair of coordinates on the taste map for visual effects, and information indicating the type of visual effects is also associated with each pair of coordinates. The effect analyzing unit 34 identifies the type of visual effects by analyzing a scene. By referring to the taste map for visual effects, the taste determining unit 46 determines a taste corresponding to the type of visual effects as the taste of that scene.

Taste identification information and a sensibility keyword are associated with each pair of coordinates on the taste map for audio, and audio information (such as information indicating the speaking speed, information indicating the emotion of the person, information indicating the sex of the person, or information indicating the age of the person) is also associated with each pair of coordinates. The audio analyzing unit 40 analyzes audio data that accompanies scene data. By referring to the taste map for audio, the taste determining unit 46 determines a taste corresponding to audio information obtained by the analysis as the taste of that scene.

Taste identification information and a sensibility keyword are associated with each pair of coordinates on the taste map for music, and music information (such as information indicating the type of music, information indicating the type of rhythm, or information indicating the type of principal instrument(s)) is also associated with each pair of coordinates. The music analyzing unit 42 analyzes music data that accompanies scene data. By referring to the taste map for music, the taste determining unit 46 determines a taste corresponding to music information obtained by the analysis as the taste of that scene.

As has been described above, the taste determining unit 46 identifies the taste of a scene by using at least one taste among a taste identified from a hue or tone (first taste), a taste identified from visual effects (second taste), a taste identified from audio (third taste), and a taste identified from music (fourth taste). In the case of using the first taste, the taste map for colors is used. In the case of using the second taste, the taste map for visual effects is used. In the case of using the third taste, the taste map for audio is used. In the case of using the fourth taste, the taste map for music is used. In the case of identifying the taste of a scene by using multiple tastes, the taste determining unit 46 calculates, for example, on the taste map 72, the average, median, or centroid of taste values of the multiple tastes, and determine a taste corresponding to the average, median, or centroid as the taste of the scene.

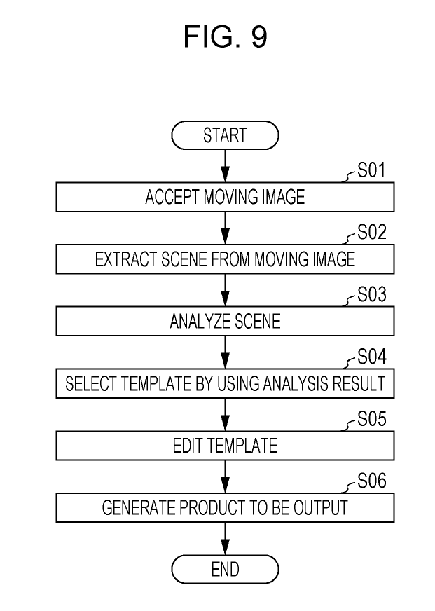

Hereinafter, a process performed by the template management apparatus 10 will be described in detail with reference to FIG. 9. FIG. 9 is a flowchart illustrating that process.

At first, the user designates, on the terminal apparatus 12, a moving image that the user wants to use, and gives a template selecting instruction. Accordingly, data on the designated moving image and information indicating the template selecting instruction are transmitted from the terminal apparatus 12 to the template management apparatus 10, and are accepted by the template management apparatus 10 (S01). The scene extracting unit 18 extracts multiple scenes from the moving image by applying shot boundary detection to the accepted moving image data (S02).

Next, for each scene, the moving image analyzing unit 20 analyzes at least one of the hue or tone of the scene, the type of visual effects in the scene, audio data that accompanies the scene, and music data that accompanies the scene, and determines the taste of the scene on the basis of the analysis results (S03). Accordingly, scene taste information indicating a taste is generated for each scene. In addition, a scene sensibility keyword indicating a taste may be generated. For each scene, the moving image analyzing unit 20 may also identify the type of a main subject represented in the scene (such as a person, a still life, an animal, or a landscape), analyze the attribute of the moving image data (such as the date and time and the place where the image has been captured, the season and weather when the image has been captured, the image capturing conditions, and format), or generate text data from the audio data.

In addition, the moving image processing unit 22 may extract, from data on each scene, data on a still image where a main subject is represented, generate video data from data on each scene, or generate animation in the Gif format from data on each scene.

Next, the template selecting unit 24 selects one or more templates that are in harmony with each scene, from a template collection stored in the template storage unit 16, by using template taste information and scene taste information (S04). The template selecting unit 24 may select, for example, a template with the same taste as the taste of a scene, or may select a template that has a taste included in a harmonious range of the taste of a scene. The template selecting unit 24 may select a template that is in harmony with a scene by using a template sensibility keyword and a scene sensibility keyword. The template selecting unit 24 may select a template that is in harmony with each scene, or may select a template that is in harmony with a scene selected by the user. In another example, the template selecting unit 24 may select a template that is in harmony with multiple scenes. The template selecting unit 24 may select a template with the same number of image display areas as the number of still images extracted from a scene. For example, when three still images are extracted, a template with three image display areas is selected.

The template selecting unit 24 selects one or more templates that are in harmony with a scene by using, for example, the result of analyzing a main subject represented in the scene, the result of analyzing visual effects, the result of analyzing a hue or a tone, the result of analyzing the attribute of the scene, the result of analyzing audio, and the result of analyzing music.

In the case of using the result of analyzing a main subject, if the main subject is a landscape, in order to appropriately represent that landscape, the template selecting unit 24 preferentially selects a template in which a relatively large image is used as the background. If the main subject is food, the template selecting unit 24 preferentially selects a template that has a taste for strikingly representing a still life.

In the case of using the result of analyzing visual effects, when consecutive images of an animal are captured, if the movement of the animal is dynamic, the template selecting unit 24 preferentially selects a template that has a dynamic taste. The template selecting unit 24 may select a template in accordance with visual effects at the time of switching scenes.

In the case of using the result of analyzing a hue or a tone, the template selecting unit 24 selects a template that has a taste determined from the hue or tone.

In the case of using the result of analyzing the attribute, if moving image attribute information includes information indicating the place where the image has been captured, the template selecting unit 24 selects a template regarding that place. The template selecting unit 24 preferentially selects a template in which, for example, features of the place where the image has been captured are represented, or a template in which features of a nation including that place are represented. In short, the template selecting unit 24 selects a template that has a taste close to an impression that a person has towards the place where the image has been captured, or a template that has a taste close to an impression that a person has towards a nation including that place.

In the case of using the result of analyzing audio, the template selecting unit 24 selects a template that has a taste determined from the audio. For example, when audio is the voice of a middle-aged man and the speaking speed is relatively slow, it is determined that the taste is “formal”, and a template that has the taste “formal and classical” is preferentially selected. A rectangular area is used as an image display area included in that template. In contrast, when audio is the voice of a young woman and is enjoyable conversation, a template that has the taste “fresh” is preferentially selected, and a round image display area is used.

Data on the selected template(s) is transmitted from, for example, the template management apparatus 10 to the terminal apparatus 12. The selected template(s) is/are displayed on the UI unit 58 of the terminal apparatus 12. For example, the thumbnail image(s) of the selected template(s) is/are displayed. A list of the selected template(s) may be displayed, or a taste map may displayed on the UI unit 58, and additionally the selected template(s) may be displayed on that taste map.

Next, the template(s) is/are edited (S05). In doing so, a compilation that is based on each template is generated. For example, the user uses the terminal apparatus 12 to edit the details of the image display area or the character string display area. Specifically, an image or characters included in the template is/are edited, or the position or color of a display area is changed. The template editing unit 26 may also combine a still image, a video image, or Gif animation extracted from a scene with the template. For example, a still image, a video image, or Gif animation representing a main subject is combined with an image display area in the template. Needless to say, a still image, a video image, or Gif animation designated by the user may be combined with the template. For example, each of a still image, a video image, and Gif animation (simplified video) may be combined with an image display area in the same template, thereby generating three types of compilations (products). In short, the following compilations may be generated: when a still image is combined with the template, a compilation of the still image type is generated; when a video image is combined with the template, a compilation of the video image type is generated; and, when Gif animation is combined with the template, a compilation of the simplified video type is generated. Accordingly, it takes less effort for the user to generate three types of compilations than in the case of manually generating three types of compilations. In another example, among the above-mentioned three types of compilations, a compilation designated by the user may be generated. In short, content selected by the user from among a still image, a video image, and Gif animation may be combined with the template.

In this case, the editing assisting unit 28 may assist the user in editing the template. The editing assisting unit 28 may propose, for example, the color of characters or background included in the template to the user such that the color fits the taste of a scene. For example, a color that has the same taste as the taste of a scene, or a color that has a taste included in the harmonious range of the taste of a scene is proposed. Information indicating the proposed color of the characters or background is displayed on the UI unit 58 of the terminal apparatus 12. In addition, the editing assisting unit 28 may propose the color of the frame of an image display area such that the color fits the tone or hue of a scene.

The editing assisting unit 28 may also propose the arrangement position of an object included in the template. In the case where multiple main subjects are detected, the editing assisting unit 28 may propose the order of arranging still images representing the main subjects in accordance with the degree of significance of each main subject. Information indicating the proposed arrangement position or the arrangement order is displayed on the UI unit 58 of the terminal apparatus 12.

In addition, in the case where a still image to be combined with an image display area in the template is larger than that image display area, the editing assisting unit 28 may trim the still image such that the still image may be displayed within the image display area. In order that, for example, a main subject represented in a still image be arranged in the center of an image display area, the editing assisting unit 28 may arrange the still image in the image display area and trim the still image.

The editing assisting unit 28 may also combine text extracted from the audio data with the template. The editing assisting unit 28 may arrange that text adjacent to an image display area, for example.

Next, the template editing unit 26 generates a product to be output, from a compilation generated on the basis of the template (S06). For example, a compilation generated by combining a still image with the template is a product of the still image type. In addition, a compilation generated by combining a video image with the template is a product of the video image type. In addition, a compilation generated by combining Gif animation with the template is a product of the Gif type. For example, using the terminal apparatus 12, the user gives an instruction to generate any of a product of the still image type, a product of the video image type, and a product of the Gif type. In accordance with the instruction, the template editing unit 26 generates a product. For example, in the case where a low-speed communication line is used, a product of the still image type or a product of the Gif type may be generated; and, in the case where a high-speed communication line is used, a product of the video image type may be generated. In the case where a product is to be printed, a product of the still image type may be generated.

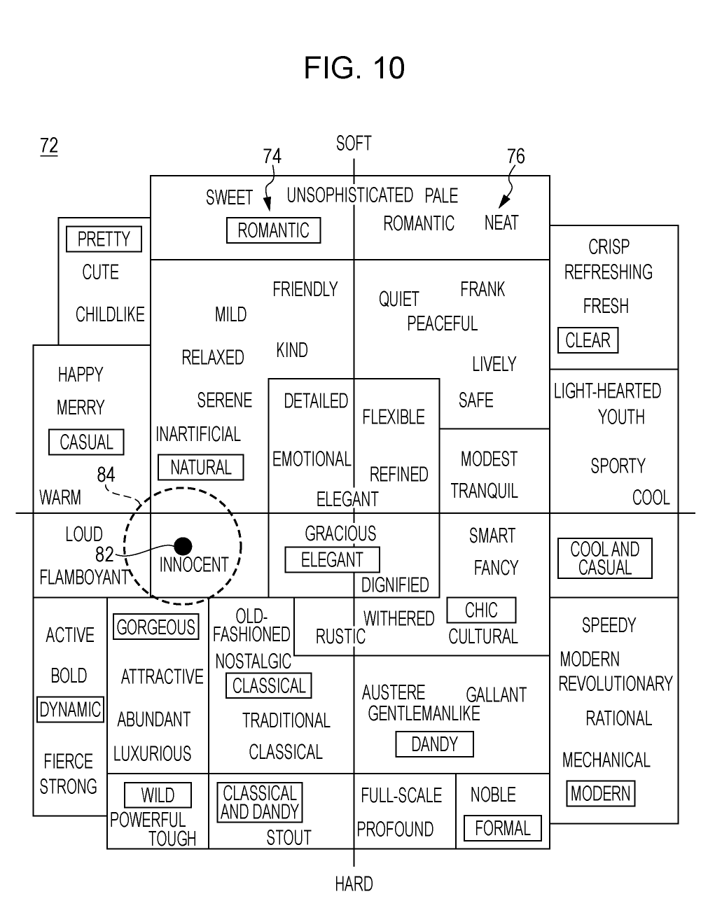

Hereinafter, a process performed by the template selecting unit 24 will be described in detail using specific examples. First, referring to FIG. 10, a first specific example will be described. FIG. 10 illustrates an example of the taste map. Reference numeral 82 in FIG. 10 indicates the taste value (a pair of coordinates corresponding to the taste) of a scene. The taste of the scene is “natural”, and the scene sensibility keyword is “innocent”. The taste of the scene is, for example, any one taste among a taste identified from a hue or tone (first taste), a taste identified from visual effects (second taste), a taste identified from audio (third taste), and a taste identified from music (fourth taste). A taste adopted from the first, second, third, and fourth tastes as the taste of the scene may be designated by the user or may be set in advance, for example.

The template selecting unit 24 may select a template whose taste belongs to the area of the taste “natural”, or may select a template that has a taste associated with the pair of coordinates indicated by reference numeral 82. In doing so, a template that has the same taste as the scene is selected. In short, a template that is in harmony with the scene is selected.

In another example, the template selecting unit 24 may define a harmonious range 84 of the scene taste, and may select a template whose taste is included in that harmonious range 84. In doing so, a template that is in harmony with the scene is selected. The harmonious range 84 is, for example, a circular area with a preset diameter around a center position that is the taste value (the pair of coordinates indicated by reference numeral 82) of the scene. Needless to say, the harmonious range 84 may be a rectangular area. In addition, the taste value of the scene may not necessarily be the center position of the harmonious range. In the example illustrated in FIG. 10, a template whose taste belongs to “natural”, a template whose taste belongs to “casual”, and a template whose taste belongs to “gorgeous” are selected.

In another example, the template selecting unit 24 may select a template associated with the same template sensibility keyword as the scene sensibility keyword “innocent”, or may select a template whose template sensibility keyword is included in the harmonious range 84. In doing so, a template that is in harmony with the scene is selected.

In yet another example, the template selecting unit 24 may identify a sample image whose taste belongs to the area of the taste “natural” and may select a template in which that sample image is set, or may identify a sample image whose taste is included in the harmonious range 84 and may select a template in which that sample image is set. In doing so, a template that is in harmony with the scene is selected.

On the taste map 72, the template selecting unit 24 may adopt a taste adjacent to the taste of the scene as the taste of a harmonious range. For example, the tastes “casual”, “elegant”, and so forth that are adjacent to the taste “natural” of the scene are adopted as the tastes of a harmonious range. In this case, a template whose taste belongs to “natural”, a template whose taste belongs to “casual”, and a template whose taste belongs to “elegant” are selected.

The template selecting unit 24 may select, from among multiple templates whose tastes are included in a harmonious range, a template that has a taste closer to the taste of the scene (the taste corresponding to the pair of coordinates indicated by reference numeral 82) as a template that has a higher degree of harmony. The template selecting unit 24 forms, for example, multiple concentric harmonious ranges around a center position that is the taste value (the pair of coordinates indicated by reference numeral 82) of the scene, and selects a template whose taste is included in a harmonious range closer to the center position as a template that has a higher degree of harmony with the scene. For example, a template whose taste is included in a harmonious range closest to the center position corresponds to a template whose degree of harmony with the scene is “high”; a template whose taste is included in a harmonious range second closest to the center position corresponds to a template whose degree of harmony with the scene is “intermediate”; and a template whose taste is included in a harmonious range third closest to the center position corresponds to a template whose degree of harmony with the scene is “low”. Note that four or more harmonious ranges may be set.

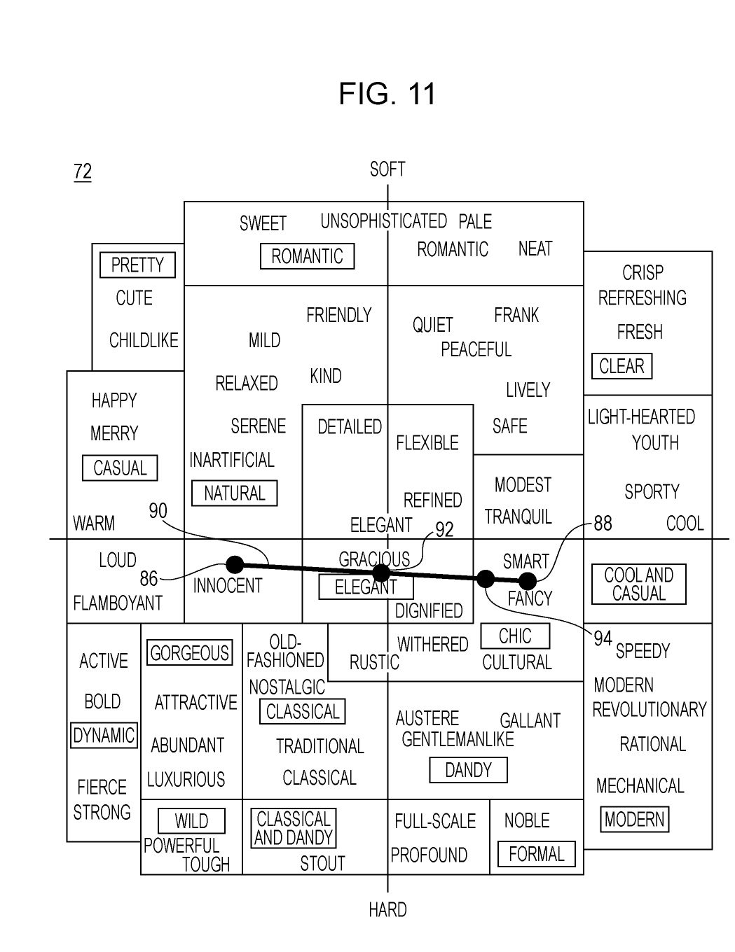

Hereinafter, referring to FIG. 11, a second specific example will be described. FIG. 11 illustrates an example of the taste map. Reference numerals 86 and 88 in FIG. 11 indicate the taste values (pairs of coordinates corresponding to the tastes) of a scene.

A taste A indicated by reference numeral 86 is “natural”, and the scene sensibility keyword is “innocent”. The taste A is, for example, any one taste among a taste identified from a hue or tone (first taste), a taste identified from visual effects (second taste), a taste identified from audio (third taste), and a taste identified from music (fourth taste).

A taste B indicated by reference numeral 88 is “chic”, and the scene sensibility keyword is “fancy”. The taste B is, for example, any one taste among the above-mentioned first taste, second taste, third taste, and fourth taste, and is a taste determined on the basis of a standard different from that of the taste A.

A taste adopted from the first, second, third, and fourth tastes as the taste of the scene may be designated by the user or may be set in advance, for example. It is assumed that, for example, the taste A is the first taste identified from a hue or tone, and the taste B is the second taste identified from visual effects.

The template selecting unit 24 forms, for example, a line segment 90 connecting the pair of coordinates indicated by reference numeral 86 and the pair of coordinates indicated by reference numeral 88, and, on the line segment 90, obtains a midpoint 92 between the pair of coordinates indicated by reference 86 and the pair of coordinates indicated by reference numeral 88. A taste corresponding to the midpoint 92 corresponds to the representative taste of the scene. The representative taste is, for example, “elegant”. In this case, the template selecting unit 24 may select a template whose taste belongs to the area of the representative taste “elegant”, or may select a template that has a taste corresponding to the midpoint 92. In doing so, a template that is in harmony with the scene is selected. In another example, the template selecting unit 24 may obtain a pair of average coordinates of the pair of coordinates indicated by reference numeral 86 and the pair of coordinates indicated by reference numeral 88, and a taste corresponding to the pair of average coordinates as the representative taste. In yet another example, the template selecting unit 24 may adopt, as the representative taste, a taste corresponding to the centroid of the pair of coordinates indicated by reference numeral 86 and the pair of coordinates indicated by reference numeral 88. In yet another example, the template selecting unit 24 may identify a sensibility keyword corresponding to the midpoint 92, the average position, or the centroid, and may select a template associated with that sensibility keyword. In the example illustrated in FIG. 11, a template associated with the template sensibility keyword “gracious” is selected.

In the case where the user designates the degree of significance of each analysis element, the template selecting unit 24 applies a weighting process to the tastes A and B in accordance with the degrees of significance. A taste obtained by this weighting process is adopted as the representative taste, and a template that has the representative taste is selected. For example, in the case where the degree of significance of visual effects is higher than that of a hue or tone, the template selecting unit 24 adopts a position 94 closer to the pair of coordinates indicated by reference numeral 88 than the midpoint 92 on the line segment 90 as the representative point, and selects a template that has the representative taste corresponding to the position 94. In the example illustrated in FIG. 11, the representative taste is, for example, “chic”. In this case, the template selecting unit 24 selects a template that belongs to an area whose taste belongs to the representative taste “chic”. The template selecting unit 24 determines the representative point in accordance with the difference between the degrees of significance of the tastes A and B. The higher the degree of significance of the taste B than the degree of significance of the taste A, a position closer to the pair of coordinates indicated by reference numeral 88 will be selected as the representative point; and the higher the degree of significance of the taste A than the degree of significance of the taste B, a position closer to the pair of coordinates indicated by reference numeral 86 will be selected as the representative point.

In yet another example, the template selecting unit 24 may identify a sensibility keyword corresponding to the position 92, and may select a template associated with that sensibility keyword. In the example illustrated in FIG. 11, a template associated with the sensibility keyword “gracious” is selected.

In the case where the user enters three or more tastes among the first, second, third, and fourth tastes, the same or similar process is performed to determine the representative taste or the representative point, and a template corresponding to the representative taste or the representative point is selected.

Hereinafter, the results of analyzing a moving image will be described using a specific example. For example, it is assumed that a moving image captured during a trip in fall is input to the template management apparatus 10 and is analyzed by the moving image analyzing unit 20. The following are the analysis results.

The main subject analysis result is as follows.

Main subject: landscape (70%), still life (food) (20%), person (5%), and others (5%).
In short, a landscape, a still life, a person, and other objects are represented as subjects in the moving image. The evaluation value (the occupied area, the appearance time, or the product of the occupied area and the appearance time) of the landscape is 70% of the total; the evaluation value of the still life is 20%; the evaluation value of the person is 5%; and the evaluation value of the other objects is 5%.

The visual effects analysis result is as follows.

Visual effects: fade (80%), and none (20%).
In short, “fade” is used as visual effects in 80% of the moving image.

The tone analysis result is as follows.

Tone: main tones include “warm color”, “red”, and “orange”; and a sub tone is “blue”.

The result of analyzing moving image attribute information is as follows.

Image capturing time: 10/20/20XX
Image capturing place: Kyoto (Japan)

### Season: Fall

### Weather: Sunny

In short, the moving image has been captured on Oct. 20, 20XX, and the image capturing place is Kyoto. The season is fall, and the weather of the image capturing day is sunny.

The audio analysis result is as follows.

Audio: low (60%), silent (20%), and lively (20%).
In short, “low audio” is recorded in 60% of the moving image, and “lively audio” is recorded in 20% of the moving image. No audio is recorded in 20% of the moving image.

As a result of the music analysis, no music is recorded in the moving image. In addition, as a result of text recognition processing, text data is extracted from the moving image.

For example, it is assumed that three scenes are extracted from the moving image. In this case, the template selecting unit 24 preferentially selects the following templates, for example.
a template with three image display areas;
a template in which a relatively large image is used as the background;
a template that suits representation of a still life (food);
a template that has a warm color and a casual taste;
a template that suits representation of fall; and
a template related to Kyoto (Japan).

In the case where three scenes are extracted from the moving image, still images are extracted from the individual scenes, thereby generating three still images. In order to combine the three still images with a template, a template that has three image display areas is preferentially selected. In short, the template selecting unit 24 preferentially selects a template that is in harmony with the scenes (moving image) and that has the same number of image display areas as the total number of the still images. In the above-described example, a template that is in harmony with the three scenes and that has three image display areas is preferentially selected. In the above-described example, the three scenes have the same taste, and thus a template with that taste is preferentially selected. In the case where the scenes have different tastes, a template with an average taste may be preferentially selected, or a template with each of the tastes may be preferentially selected.

As a result of the main subject analysis, a landscape is identified as a main subject. In order to appropriately represent the landscape, a template in which a relatively large image is used as the background is preferentially selected.

As a result of the moving image analysis, it is determined that the taste of the moving image includes a warm color and a casual taste. Thus, a template that has a warm color and a casual taste is preferentially selected.

Since the moving image has been captured in fall, a template for fall is preferentially selected. Since the place where the moving image has been captured is Kyoto (Japan), a template related to Kyoto (Japan) is preferentially selected.

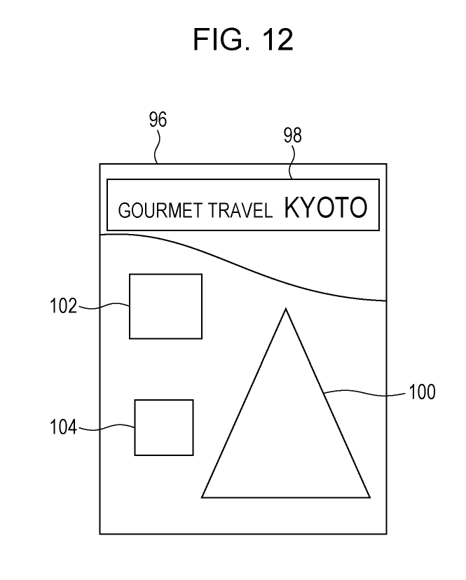

Hereinafter, a compilation will be described in detail with reference to FIG. 12. FIG. 12 illustrates an example of a compilation. A compilation 96 is a compilation generated on the basis of the template 62 illustrated in FIG. 6. In short, the template selecting unit 24 preferentially selects the template 62, and the compilation 96 is a compilation generated on the basis of the template 62. Like the template 62, the compilation 96 includes a character string display area, a background area, and image display areas.

Instead of the sample character string 64 illustrated in FIG. 6, another character string 98 is entered in the character string display area. For example, text extracted from the moving image may be entered in the character string display area, or a character string entered by the user may be entered in the character string display area.

Instead of the sample image 66 illustrated in FIG. 6, an image 100 is entered in the background area. The image 100 may be an image designated by the user, or a still image extracted from the moving image, in which a main subject is represented. Since a “landscape” is detected as a main subject in the above-described example, a still image (image 100) in which the “landscape” is represented is extracted from the moving image and is entered in the background area. In the case of entering a still image extracted from the moving image in the background area, the still image may be trimmed such that the size of the still image fits the size of the background area.

Instead of the sample images 68 and 70 illustrated in FIG. 6, images 102 and 104 are entered in the image display areas. The images 102 and 104 may be images designated by the user, or still images extracted from the moving image. In the case of entering a still image extracted from the moving image in an image display area, the still image may be trimmed such that the size of the still image fits the size of the image display area.

Since the compilation 96 includes the images 100, 102, and 104 serving as still images, the compilation 96 is a product of the still image type. In the case where a scene (video image) extracted from the moving image is entered in the background area or an image display area, the generated compilation corresponds to a product of the video image type. In the case where Gif animation extracted from the moving image is entered in the background area or an image display area, the generated compilation corresponds to a product of the Gif type.

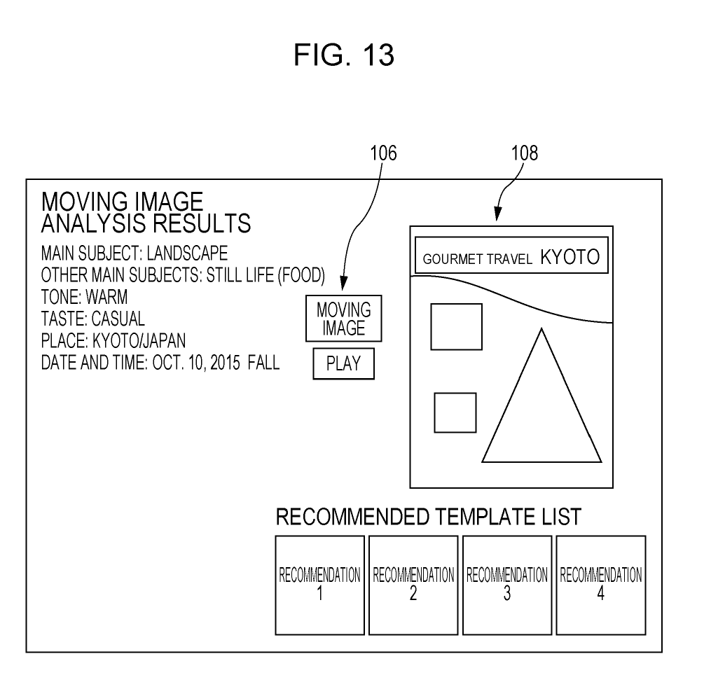

Hereinafter, a template selecting screen will be described in detail with reference to FIG. 13. FIG. 13 illustrates an example of a template selecting screen. Data on the template selecting screen is transmitted from the template management apparatus 10 to the terminal apparatus 12, and the template selecting screen is displayed on the UI unit 58 of the terminal apparatus 12. On the template selecting screen, the results of analyzing the moving image and a template collection selected by the template selecting unit 24 are displayed. As results of analyzing the moving image, for example, information regarding a main subject, information regarding a tone, information indicating a taste, information indicating an image capturing place, and information indicating an image capturing date and time are displayed. A template collection selected by the template selecting unit 24 is displayed as a recommended template list. For example, the thumbnail images of templates are generated, and a list of these thumbnail images is displayed. In the example illustrated in FIG. 13, four recommended templates are selected and displayed. A moving image 106 that has been analyzed may be displayed on the template selecting screen. A play button is displayed on the template selecting screen, and, when the user presses the play button, the moving image 106 is played. A compilation 108 may be displayed on the template selecting screen. A still image and text extracted from the moving image are combined in the compilation 108. The still image is a still image representing a main subject. Since the compilation 108 in which the extracted still image and text are combined is presented, the user is able to more intuitively have the final image of a generated compilation than in the case where neither still image nor text is combined with a template.

According to the exemplary embodiment described above, a scene is extracted from a moving image, and the taste of the scene (moving image) is determined on the basis of various types of information included in the moving image. For example, the taste is determined using, besides the hue or tone of the scene, as information unique to the moving image, information regarding visual effects, audio data, and music data. In doing so, the taste of the moving image is more accurately determined than in the case of using only character information extracted from the moving image. In addition, a template that has the same taste as the taste of the scene or a template that has a taste included in a harmonious range is selected. In doing so, a template that is uniform with the design of the scene is selected, compared with the case of using only character information extracted from the moving image. In other words, a template that has the same taste as the taste of the scene has no difference or a relatively small difference from the taste (impression) of the scene. Thus, that template may be evaluated as a template that is in harmony with the scene. In addition, a template whose taste is included in the harmonious range has a relatively small difference from the taste of the scene. Thus, that template may be evaluated as a template that is in harmony with the scene. Therefore, according to the exemplary embodiment, a template that is uniform with the taste of the scene, that is, a template that is in harmony with the scene, is selected. By selecting a template using sensibility keywords, a selecting process using tastes is supplemented, thereby selecting a template that suits the scene. According to the exemplary embodiment, a harmonious combination of a scene and a template as a whole is provided.

The scene extracting unit 18 may extract, from the moving image, a scene that is in harmony with a template selected by the user. For example, a list of templates is displayed on the UI unit 58 of the terminal apparatus 12, and the user selects a target template from the list. Like the above-described exemplary embodiment, the scene extracting unit 18 extracts multiple scenes from the moving image. Like the above-described exemplary embodiment, the moving image analyzing unit 20 determines the taste of each scene. By using template taste information on a template selected by the user and scene taste information on each scene, the scene extracting unit 18 selects a scene that is in harmony with the template from among multiple extracted scenes. The scene extracting unit 18 may select, for example, a scene with the same taste as the taste of the template, or may select a scene that has a taste included in a harmonious range of the taste of the template. Like the above-described exemplary embodiment, the scene extracting unit 18 may select a scene that is in harmony with the template by using sensibility keywords. A scene selected in this manner is displayed as the analysis result on the UI unit 58 of the terminal apparatus 12. Accordingly, a harmonious combination of a scene and a template as a whole is provided. In addition, a still image and text information may be extracted from the selected scene, and the still image and text may be combined with a template selected by the user.

The above-described template management apparatus 10 is implemented by cooperation between hardware resources and software, for example. Specifically, the template management apparatus 10 includes a processor such as a central processing unit (CPU) (not illustrated). The function of each unit of the template management apparatus 10 is implemented by reading and executing, by the processor, a program stored in a storage device (not illustrated). The above-mentioned program is stored in a storage device via a recording medium such as a compact disc (CD) or a digital versatile disc (DVD), or via a communication path such as a network. Alternatively, each unit of the template management apparatus 10 may be implemented by hardware resources such as a processor and an electronic circuit. In that implementation, a device such as a memory may be used. In another example, each unit of the template management apparatus 10 may be implemented by a digital signal processor (DSP) or a field programmable gate array (FPGA).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that associatively stores, for each template, the template and a degree of first impression similarity indicating an impression of the template;
a scene extracting unit that extracts a scene from a moving image;
a determining unit that determines an impression of the extracted scene; and
a providing unit that provides a harmonious combination of the scene and a template by using a degree of second impression similarity indicating the impression of the scene, and the degree of first impression similarity.

2. The information processing apparatus according to claim 1, wherein the determining unit determines the impression of the scene on the basis of at least one of a tone of the scene, a type of visual effects used in the scene, audio data that accompanies the scene, and music data that accompanies the scene.

3. The information processing apparatus according to claim 1, wherein the providing unit provides a template that is in harmony with the scene by using the degree of first impression similarity and the degree of second impression similarity.

4. The information processing apparatus according to claim 1, wherein the scene extracting unit extracts, from the moving image, a scene that is in harmony with a designated scene, by using the degree of first impression similarity and the degree of second impression similarity.

5. The information processing apparatus according to claim 1, further comprising a first combining unit that combines a still image extracted from the scene or the scene with a template that is in harmony with the scene.

6. The information processing apparatus according to claim 5, wherein
a template includes an image display area in which an image is displayed, and
the first combining unit combines a plurality of still images extracted from the scene with a template that is in harmony with the scene and that has a same number of image display areas as a number of the extracted still images.

7. The information processing apparatus according to claim 1, further comprising a generating unit that combines the scene and a still image extracted from the scene with a template that is in harmony with the scene, and generates a plurality of types of products.

8. The information processing apparatus according to claim 5, further comprising a still image extracting unit that extracts, from the scene, the still image in which a main subject is represented.

9. The information processing apparatus according to claim 1, further comprising:
a character information generating unit that generates character information from audio data that accompanies the scene; and
a second combining unit that combines the character information with a template that is in harmony with the scene.

10. An information processing method for a computer, the computer including a memory that associatively stores, for each template, the template and a degree of first impression similarity indicating an impression of the template, the method comprising:
extracting a scene from a moving image;
determining an impression of the extracted scene; and
providing a harmonious combination of the scene and a template by using a degree of second impression similarity indicating the impression of the scene, and the degree of first impression similarity.

11. A non-transitory computer readable medium storing a program causing a computer to execute a process, the computer including a memory that associatively stores, for each template, the template and a degree of first impression similarity indicating an impression of the template, the process comprising:
extracting a scene from a moving image;
determining an impression of the extracted scene; and
providing a harmonious combination of the scene and a template by using a degree of second impression similarity indicating the impression of the scene, and the degree of first impression similarity.
